(19) United States
(12) Patent Application Publication
(10) Pub. No.: US 2011/0058208 A1
(43) Pub. Date: Mar. 10, 2011

(54) PRINT SYSTEM IN WHICH A TERMINAL USES A PRINT DEVICE THROUGH THE INTERNET

(75) Inventor: Teruaki TAKAHASHI, Saitama (JP)

(73) Assignee: RICOH COMPANY, LTD., Tokyo (JP)

(21) Appl. No.: 12/869,826

(22) Filed: Aug. 27, 2010

(30) Foreign Application Priority Data
Sep. 8, 2009 (JP) NO. 2009-207260
Jun. 2, 2010 (JP) NO. 2010-127294

(51) Int. Cl. G06K 15/00

(52) U.S. Cl. 358/1.14; 358/1.15

(57) ABSTRACT

A print system, in which a terminal uses a print device through the Internet to cause the print device installed in a local network to print, includes a user checking unit configured to check whether a user is a user authorized to use the print device in the local network, an operation page providing unit configured to provide an accessible operation page to the user upon determining that the user is a user authorized to use the print device, and a print controlling unit configured to cause the print device to print according to access control information associated with the user in response to a print request received through the Internet, the print request being made by the terminal by using a printer driver of the print device, the terminal being situated outside the local network, and the printer driver being installed by use of the operation page.

### BACKGROUND OF THE INVENTION

1. Field of the Invention

The disclosures herein relate to a technology by which a terminal device uses a printer device through the Internet to print.

2. Description of the Related Art

A solution that allows easy operations to automate the setup of network information in a printer driver and a printer device operable by the printer driver is already known in the art.

As an example of a related-art technology, Japanese Patent No. 3958283 discloses a configuration in which an RFID reader transmits network information and a printer driver stored in a hard drive as attachments to an email based on information retrieved from an RFID card. A personal computer receives the email, and installs the printer driver in a storage device, followed by setting up a network environment according to the network information.

As another example of a related-art technology, Japanese Patent Application Publication No. 2006-238199 discloses a system in which an information processing apparatus has a print setting means that automatically makes settings necessary to use a printer device through the Internet to print.

In the related-art technologies described above, no consideration is given to the fact that a firewall is usually provided at the border between the Internet and a local network connected thereto. Further, no discussion is made with respect to the case in which a terminal device (e.g., mobile terminal) connected to the Internet is connected to a printer device such as a printer. Because of this, it would be difficult to use the configurations of these related-art technologies in a real environment. Since communication is performed through the Internet, security needs to be ensured. However, this is not discussed, either.

With respect to a case in which a terminal device downloads a driver through the Internet, and uses a printer device through the Internet to print, solutions to date have a problem in that no sufficient measure has been taken against changes that may be made to firewall settings at the border between networks. Further, there is a problem in that no sufficient measures have been taken against the illegal access or tampering of print data by unauthorized users and the unauthorized use of a printer.

Accordingly, it may be desirable to adapt a secure print environment provided in a local network to a configuration in which a terminal device performs printing through the Internet.

### SUMMARY OF THE INVENTION

In one embodiment, a print system in which a terminal uses a print device through the Internet to cause the print device installed in a local network to print includes: a user checking unit configured to check whether a user is a user authorized to use the print device in the local network; an operation page providing unit configured to provide an accessible operation page to the user upon determining that the user is a user authorized to use the print device; and a print controlling unit configured to cause the print device to print according to access control information associated with the user in response to a print request received through the Internet, the print request being made by the terminal by using a printer driver of the print device, the terminal being situated outside the local network, and the printer driver being installed by use of the operation page.

In one embodiment, a print control apparatus of a print system in which a terminal uses a print device through the Internet to cause the print device installed in a local network to print includes: a user checking unit configured to check whether a user is a user authorized to use the print device in the local network; an operation page providing unit configured to provide an accessible operation page to the user upon determining that the user is a user authorized to use the print device; and a print controlling unit configured to cause the print device to print according to access control information associated with the user in response to a print request received through the Internet, the print request being made by the terminal by using a printer driver of the print device, the terminal being situated outside the local network, and the printer driver being installed by use of the operation page.

In one embodiment, a method of controlling printing performed by a print control apparatus of a print system in which a terminal uses a print device through the Internet to cause the print device installed in a local network to print includes: a user checking step of checking whether a user is a user authorized to use the print device in the local network; an operation page providing step of providing an accessible operation page to the user upon determining that the user is a user authorized to use the print device; and a print controlling step of causing the print device to print according to access control information associated with the user in response to a print request received through the Internet, the print request being made by the terminal by using a printer driver of the print device, the terminal being situated outside the local network, and the printer driver being installed by use of the operation page.

According to at least one embodiment, provision is made to adapt a secure print environment provided in a local network to a configuration in which a terminal device performs printing through the Internet.

### BRIEF DESCRIPTION OF THE DRAWINGS

Other objects and further features of embodiments will be apparent from the following detailed description when read in conjunction with the accompanying drawings, in which:

FIG. 1 is a schematic diagram of the entire configuration of a print system according to an embodiment;

FIG. 2 is a drawing illustrating the apparatus configuration of the print system according to the embodiment;

FIG. 3 is a block diagram illustrating a first functional configuration of the print system according to the embodiment;

FIG. 4 is a drawing illustrating the hardware configuration of a print manager;

FIG. 5 is a drawing illustrating the data structure of an authorized printer user list according to the first functional configuration illustrated in FIG. 3;

FIG. 6 is a flowchart illustrating the process of providing a notice of an operation page according to the first functional configuration illustrated in FIG. 3;

FIG. 7 is a flowchart illustrating the process of generating a print queue at a terminal according to the first functional configuration illustrated in FIG. 3;

FIG. 8 is a flowchart illustrating a print process according to the first functional configuration illustrated in FIG. 3;

FIG. 9 is a block diagram illustrating a second functional configuration of the print system according to the embodiment;

FIG. 10 is a drawing illustrating the data structure of an access control list according to the second functional configuration illustrated in FIG. 9;

FIG. 11 is a drawing illustrating the data structure of an authorized printer user list according to the second functional configuration illustrated in FIG. 9;

FIG. 12 is a flowchart illustrating the process of providing a notice of an operation page according to the second functional configuration illustrated in FIG. 9;

FIG. 13 is a flowchart illustrating a print process according to the second functional configuration illustrated in FIG. 9;

FIG. 14 is a drawing illustrating an example of a displayed email transmitted from a print manager; and

FIG. 15 is a drawing illustrating an example of an operation page that is used for installing a printer driver.

### DESCRIPTION OF THE PREFERRED EMBODIMENTS

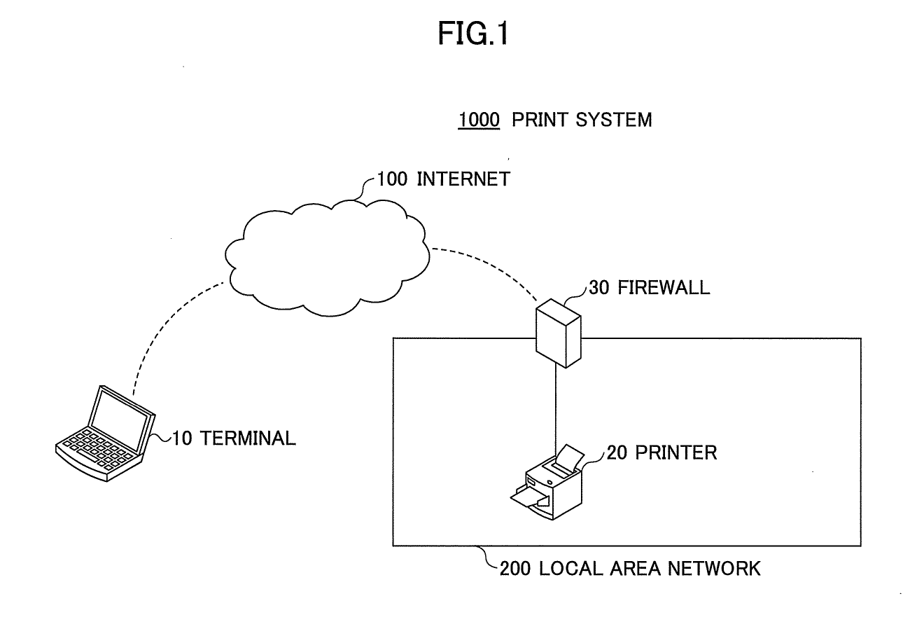

In the following, embodiments of the present invention will be described with reference to the accompanying drawings. FIG. 1 is a schematic diagram of the entire configuration of a print system according to an embodiment. In a print system 1000 illustrated in FIG. 1, a terminal 10 is connected to the Internet 100, and is capable of freely accessing Web pages. A printer 20 installed in a local area network 200 is connected to an Internet communication line through a firewall 30. The terminal 10 may not be able to reference the address of the printer 20.

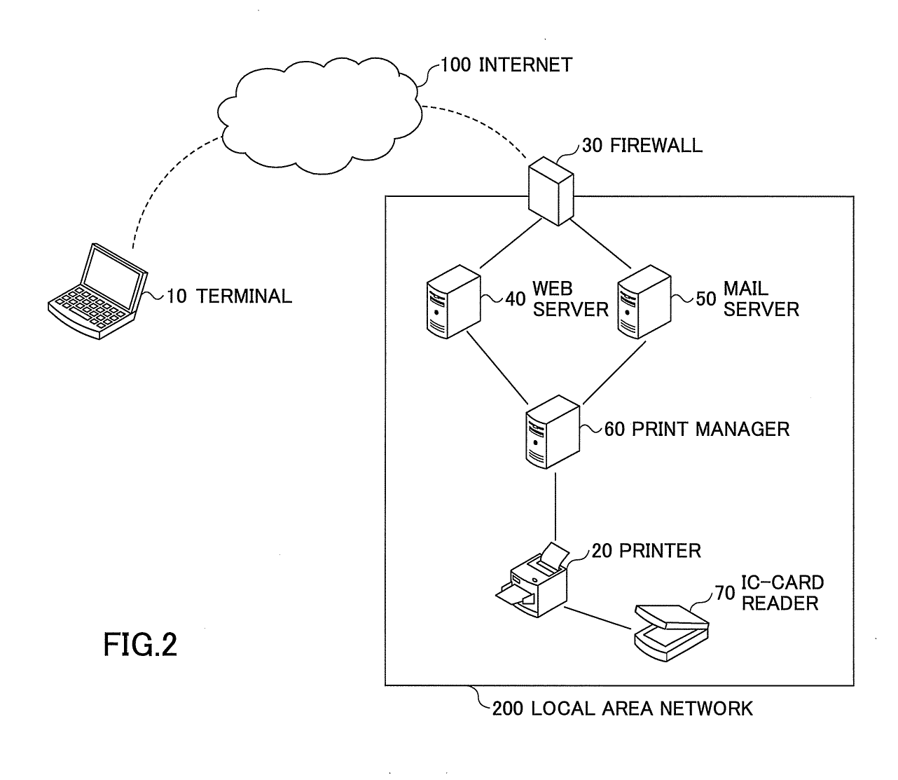

FIG. 2 is a drawing illustrating the apparatus configuration of the print system according to the embodiment. The terminal 10 and the printer 20 are the same as those illustrated in FIG. 1. The local area network 200 illustrated in FIG. 2 includes a Web server 40, a mail server 50, a print manager 60, and an IC-card reader 70 in addition to the printer 20.

The Web server 40 and the mail server 50 are both connected to the firewall 30. The print manager 60 is connected to the Web server 40 and the mail server 50. The print manager 60 is also connected to the printer 20. Moreover, the IC-card reader 70 is connected to the printer 20.

The terminal 10 sets a print queue internally by operating an operation page provided by the Web server 40. The terminal 10 uses the print queue to send print data to the Web server 40.

The firewall 30 has general security settings made thereto. According to such security settings, for example, typical print-related communication cannot pass through while communication for making Web pages available to the public and communication for transferring emails are allowed to pass through.

The Web server 40 makes an operation page available to the public, so that the terminal 10 can make a print queue by use of the operation page. The Web server 40 receives print data from the terminal 10, and transfers the received print data to the print manager 60. In response to a request from the print manager 60, the Web server 40 returns the address of an operation page that is to be made available to the public.

The mail server 50 serves to transfer the address of the Web server 40 to the terminal 10 in response to a request from the print manager 60.

The print manager 60 performs the management and control of users who use the printer 20. The print manager 60 may use user information retrieved from an IC card, for example, to determine whether the user is authorized to use the printer 20. When the user is an authorized user to use the printer 20, the print manager 60 sends, through the mail server 50 to the terminal 10, the address of an operation page made available to the public by the Web server 40. The user has been authorized to use the printer 20 in advance by using an IC card. Upon being recognized to be an authorized user, the user accesses the received address of the operation page to display the operation page at the terminal 10 to request printing. The print manager 60 converts print data produced by the terminal 10 in response to a user print request into commands decodable by the printer 20.

The printer 20 interprets the commands to print on a paper medium. The IC-card reader 70 retrieves user information from an object carried by the user. The user information read by the IC-card reader 70 is supplied to the print manager 60 via the printer 20. The IC-card reader 70 may be installed at any location in the local area network 200 as long as the IC-card reader 70 can provide user information to the print manager 60.

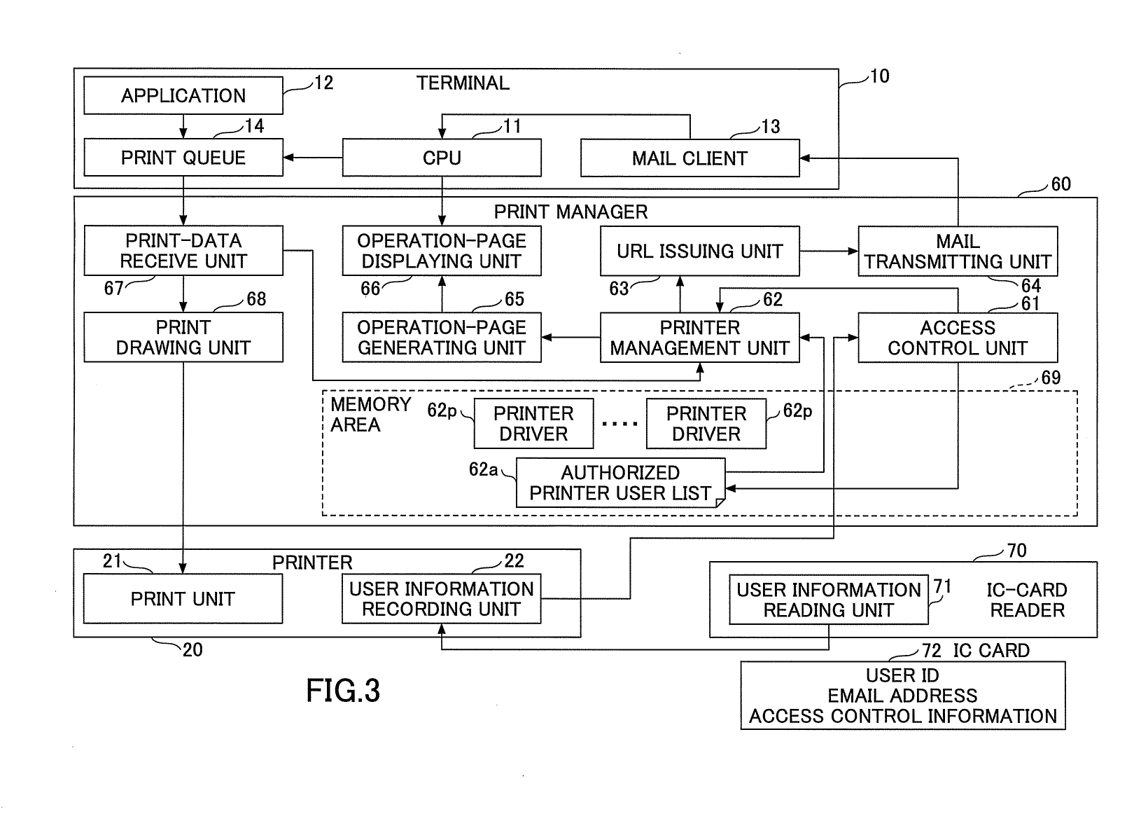

FIG. 2 shows an apparatus configuration in which the Web server 40 and the mail server 50 are provided separately from the print manager 60. As illustrated in FIG. 3, for example, the system may be configured such that the print manager 60 includes the functions of the Web server 40 and the mail server 50. FIG. 3 is a block diagram illustrating a first functional configuration of the print system according to the embodiment.

The terminal 10 includes a general Web browser 11, an application 12, and a mail client 13. It is assumed that a conventional print function (e.g., Web Point&Print) may be used to create a server print queue 14.

The Web browser 11 can open an operation page of the print manager 60.

The mail client 13 can receive and open email sent from the print manager 60.

The print manager 60 has a Web server function and a mail server function in addition to a print control function for controlling the printer 20 for printing. The print manager 60 includes an access control unit 61, a printer management unit 62, a URL issuing unit 63, a mail transmitting unit 64, an operation-page generating unit 65, an operation-page displaying unit 66, a print-data receive unit 67, and a print drawing unit 68. The URL issuing unit 63 and the mail transmitting unit 64 correspond to the mail server function, and the operation-page generating unit 65 and the operation-page displaying unit 66 correspond to the Web server function.

The access control unit 61 performs user authentication by using user information read by the IC-card reader 70 to determine whether the user is authorized to use the printer 20. The user information includes a user ID identifying a user, a user email address, and access control information. The access control information includes a printer name for identifying a printer 20 usable by the user and print functions permitted to be used with respect to the printer 20. When the user is determined to be an authorized user to use the printer 20, the access control unit 61 registers the user's user ID, email address, and access control information in an authorized printer user list 62a together with the data indicative of the present time.

The authorized printer user list 62a lists valid periods on a user-ID-specific basis with respect to users determined to be authorized printer users where the valid periods indicate periods during which printing is permitted. The authorized printer user list 62a is stored in a memory area 69. Upon expiration of a valid period, the user information is deleted.

The printer management unit 62 manages one or more printer drivers 62p that are installed in advance in the print manager 60 and stored in the memory area 69. In response to a request from the access control unit 61, the printer management unit checks the print functions permitted to be used based on the access control information specified by the user information. The printer management unit 62 then creates print queues in the memory area 69 by attaching the access control information to the printer drivers 62p based on the check results. An interface to access the print queues to be used is made available to the public on the operation page. A printer driver 62p may be configured as a common driver usable by all the model types. In this case, installing one common driver is sufficient, and there is no need to install plural drivers for respective printer model types.

The URL issuing unit 63 issues a URL that specifies the address of the operation page in response to a request from the printer management unit 62. The URL issuing unit 63 provides the email address included in the user information and the issued URL to the mail transmitting unit 64. The valid period of the issued URL may be managed by use of the authorized printer user list 62a.

The mail transmitting unit 64 attaches the URL issued by the URL issuing unit 63 to email, and sets the destination of the email to the user email address, thereby transmitting the email to a mail server to which the terminal 10 is connected.

In response to a request from the printer management unit 62, the operation-page generating unit 65 creates an interface for the print queues to which the access control information linked to the printer drivers 62p is attached.

The operation-page displaying unit 66 displays the operation page upon request from the terminal 10. The operation page may be a Web page. The operation page provides the functions used to create a print queue at the terminal 10. The period for displaying the page corresponding to the URL requested by the terminal 10 may be limited to the valid period. In such a case, the operation-page displaying unit 66 refers to the authorized printer user list 62a to acquire the valid period of the requested URL, and then compares the valid period with the present time to control display on the terminal 10.

The print-data receive unit 67 receives a print request from the print queue 14 of the terminal 10. The print request from the terminal 10 may be made by using the IPP (Internet Printing Protocol), for example. Encryption (e.g., HTTPS) using SSL may be utilized. The print request includes print data and setting information specified by the user regarding the print operation. The print-data receive unit 67 notifies the printer management unit 62 of the print request. The printer management unit 62 checks whether there is a print queue required by the print request, and also checks whether the setting information conforms to the print functions permitted for the print queue. Based on the check results, the print-data receive unit 67 uses the print drawing unit 68 to draw the print data according to the permitted print functions.

The print drawing unit 68 has the drawing function for existing printer drivers. The print drawing unit 68 uses the print data to generate image data according to the print functions permitted to the user as specified by the request from the print-data receive unit 67. The print drawing unit 68 further controls a print unit 21 of the printer 20 through the permitted print functions to print the image data.

A user permitted to use only duplex printing may request one-side printing. In such a case, duplex printing is performed without regard to the user intention through the controls as described above.

The printer 20 includes the print unit 21 having general print functions, and also includes a user information recording unit 22 that can record user information read from an IC card 72.

The IC-card reader 70 includes a user information reading unit 71 for reading user ID information and a user email address recorded in an object carried by a user such as the IC card 72

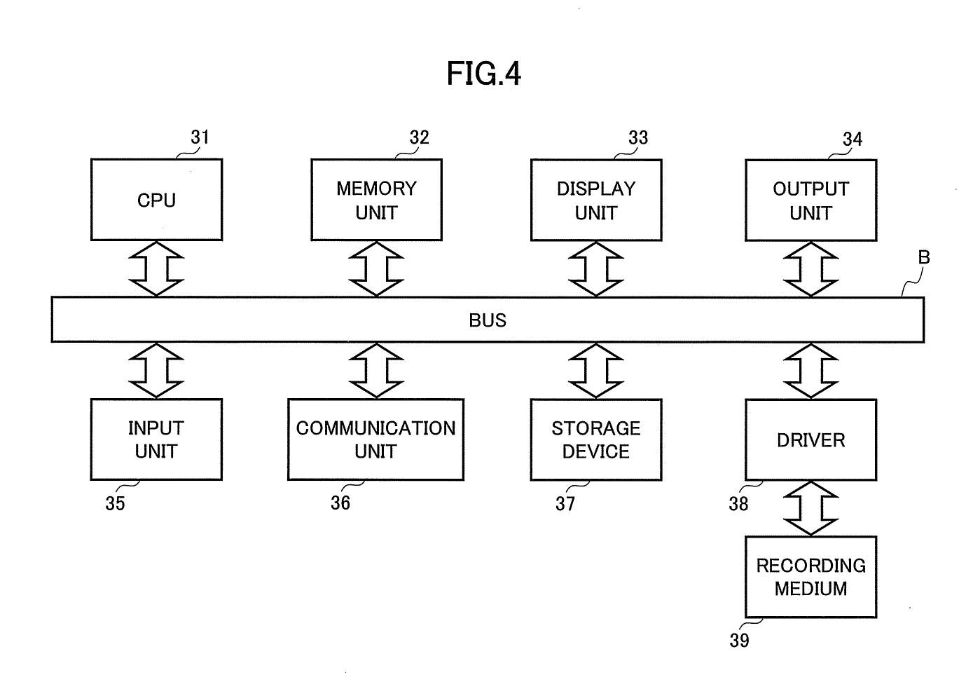

FIG. 4 is a drawing illustrating the hardware configuration of a print manager. The print manager 60 illustrated in FIG. 4 may be a computer, and includes a CPU (Central Processing Unit) 31, a memory unit 32, a display unit 33, an output unit 34, an input unit 35, a communication unit 36, a storage device 37, and a driver 38, which are connected to a system bus B.

The CPU 31 controls the print manager 60 in accordance with programs stored in the memory unit 32. The memory unit 32 may be a RAM (Random Access Memory) and a ROM (Read Only Memory), and store programs executed by the CPU 31, data subjected to processing by the CPU 31, data obtained through processing by the CPU 31, etc. Part of the memory area of the memory unit 32 is allocated as a work area used by the CPU 31.

The display unit 33 displays various types of information under the control of the CPU 31. The output unit 34 may includes a printer or the like, and is used to output various types of information in response to administrator's instruction. The input unit 35 may include a mouse and keyboard, and is used by an administrator to enter various types of information necessary for the operation of the print manager 60.

The communication unit 36 has one or more communication protocols used for the Internet, a LAN (Local Area Network), etc. The communication unit 36 serves to control communication between the printer and an external apparatus connected through the Internet, a LAN, or the like.

The storage device 37 may be a hard-disk drive unit, which stores programs and data used in various types of processing. Programs for implementing operations performed by the print manager 60 are supplied to the print manager 60 through a recording medium 39 such as a CD-ROM (Compact Disk Read Only Memory). When the recording medium 39 having programs stored therein is mounted in the driver 38, the driver 38 reads the programs from the recording medium 39, so that the programs are installed in the storage device 37 through the system bus B. One or more of the programs installed in the storage device 37 are loaded to cause the CPU to perform processing. The recording medium for storing programs is not limited to a CD-ROM, but may be any type of computer-readable medium. The programs implementing the operations of the present embodiment may alternatively be downloaded by the communication unit 36 through a network to be installed in the storage device 37. The print manager 60 may support USB (Universal Serial Bus). In such a case, the programs may alternatively be installed from an external storage device connected through a USB cable. The print manager 60 may support a flash memory such as an SD card. The programs may alternatively be installed from such a memory card.

The functional blocks 61 through 68 of the print manager 60 illustrated in FIG. 3 are implemented by the CPU 31 executing respective programs. The memory area 69 of the print manager 60 may be provided in the memory unit 32 and/or the storage device 37.

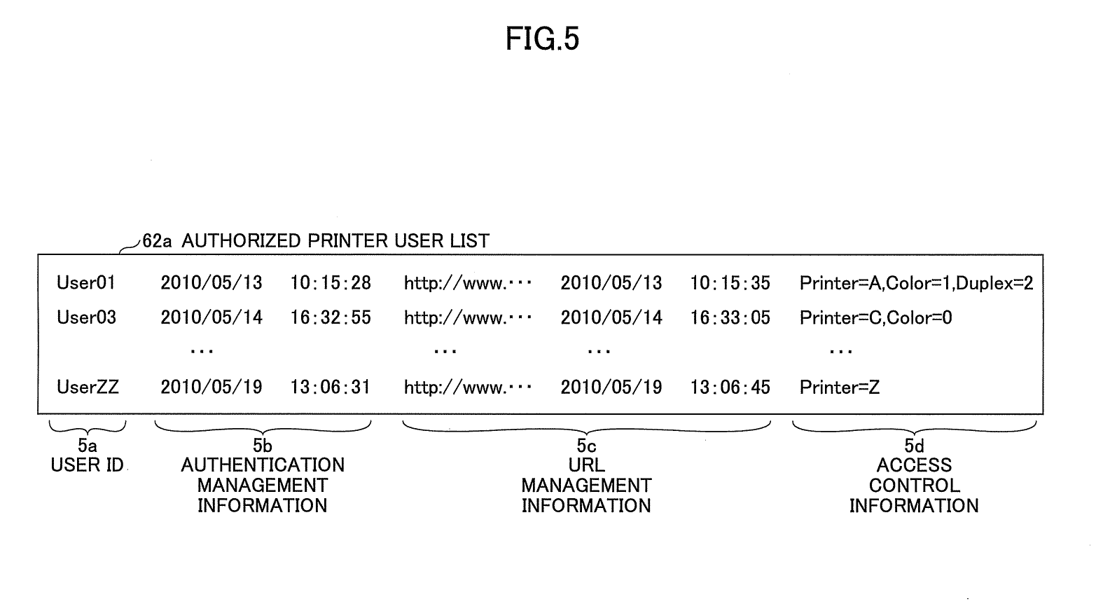

FIG. 5 is a drawing illustrating the data structure of a authorized printer user list according to the first functional configuration illustrated in FIG. 3. As illustrated in FIG. 5, the authorized printer user list 62a includes a user ID 5a, authentication management information 5b, URL management information 5c, and access control information 5d separately for each user who is authorized to be a printer user.

The user ID 5a and the authentication management information 5b are registered when the access control unit 61 authenticates a user as a printer authorized user. The user ID 5a uniquely identifies each user. The authentication management information 5b indicates the date and time of registration. Alternatively, the authentication management information 5b indicates the date and time of expiration of authentication.

The URL management information 5c indicates a URL issued by the URL issuing unit 63 and the date and time of issuance. Alternatively, the date and time may indicate the valid period of the URL. When the valid period of a URL is not an item to be controlled, the date and time of issuance may be omitted.

The access control information 5d is access control information read from the IC card 72. The access control information 5d includes a printer name identifying a printer and print functions the user is authorized to use. The access control information 5d is used to control print requests arriving from inside or outside the local area network 200.

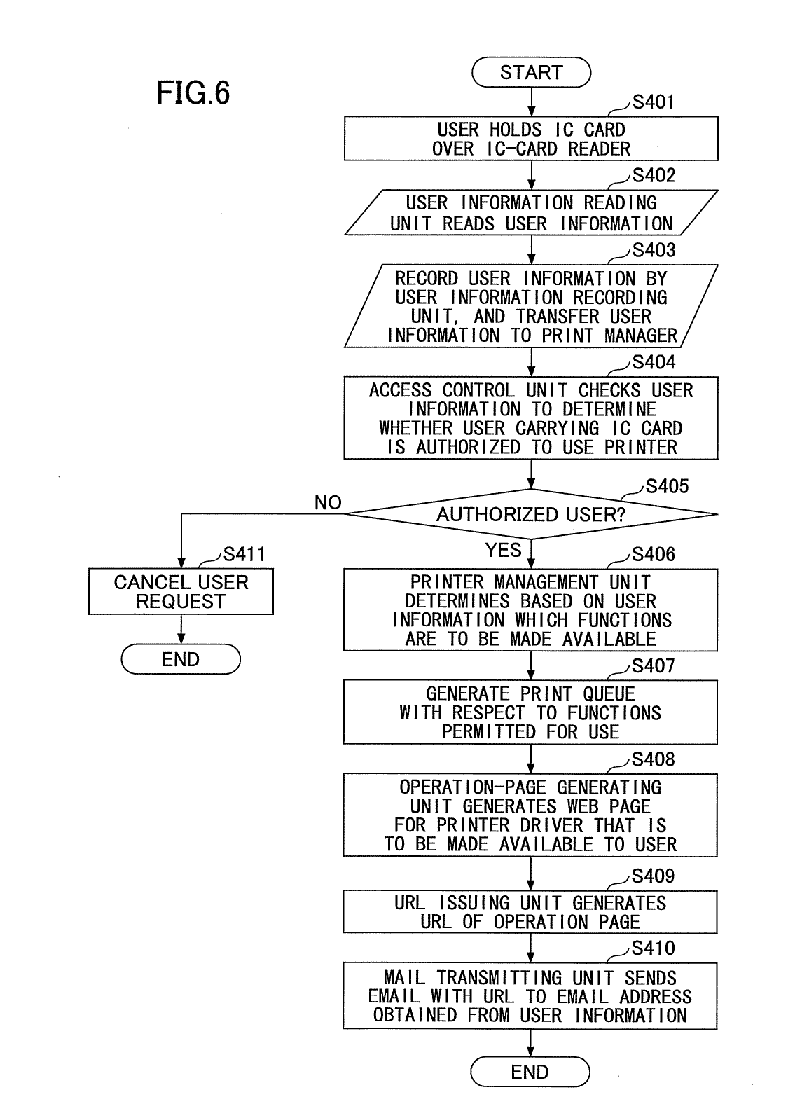

FIG. 6 is a flowchart illustrating the process of providing a notice of an operation page according to the first functional configuration illustrated in FIG. 3. In FIG. 6, a user who would like to use the printer 20 holds a carried item such as an IC card over the IC card reader to which the printer 20 is connected (S401).

The user information reading unit 71 of the IC-card reader 70 reads user information from the IC card (S402). The user information includes a user ID, a user email address, and access control information.

The printer 20 transfers the acquired user information to the print manager 60 (S403). The printer 20 may record the user information. When print data is supplied from the user, the printer 20 may request the user to enter his/her user ID, and may perform printing upon authenticating the user as a printer authorized user by use of the recorded user information. Such authentication at the time of printing makes it possible to prevent the printout from being taken by an unauthorized user. Time may also be recorded in order to provide a mechanism by which to prohibit printing after the passage of a predetermined time period.

When the print manager 60 receives the user information from the printer 20, the access control unit 61 checks based on the user information whether the user carrying the IC card is a user authorized to use the printer 20 (S404, S405). If the user is not a legitimate user, or is not a user authorized to print by use of the printer 20, the request is denied, and the procedure comes to an end (S411). The operation panel of the printer 20 may display an indication that the information provided by the IC card is not valid.

The printer management unit 62 manages plural printer drivers. In the first functional configuration, all the printer drivers 62p of the printers 20 managed by the print manager 60 are installed in the print manager 60. Disclosure of printer functions may be controlled by use of each user's access control information on a printer specific basis. In such a case, plural print queues may be installed with respect to a single printer driver. The printer management unit 62 refers to the user information to check the user's access control information (S406). For example, such a control procedure may be used that the administrator can use all the functions of the printer 20 while general users cannot use color printing. Based on the check results, print queues to which the access control information linked to the printer drivers 62p are generated (S407). These queues are automatically deleted upon passage of a predetermined time period.

The operation-page generating unit 65 generates an operation page for making the generated print queues available to the public (S408). The operation-page displaying unit 66 prepares to display the operation page that is to be made public.

The URL issuing unit 63 generates a URL of the operation page to be displayed in response to a request from the printer management unit 62 (S409). This generated URL is a unique combination of a print queue to be displayed and access control information. For example, the printer 20 having a printer name “A” may be identified as “http://www.xxx.yyy.zzz/printers/printer_a?color=0” where a print queue a is used with a monochrome setting. It may not be desirable to disclose access control information and printer information in a form that is easily recognizable to unauthorized users. In consideration of this, the portion relating to the settings of the printer 20 may be encrypted by use of a hash function as in the following example: “http://www.xxx.yyy.zzz/printers/hgdfxf2df4d”.

The mail transmitting unit 64 attaches the generated URL to email, and sends the email to an email address obtained from the user information (S410).

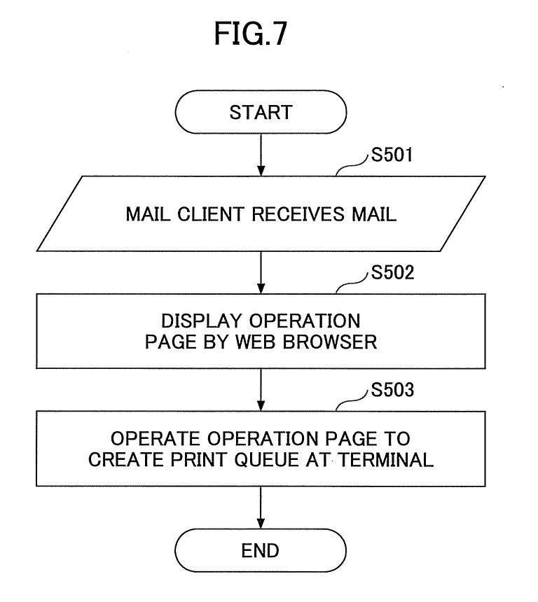

In the following, a description will be given of a print queue generating process that generates the print queue 14 at the terminal 10 upon receiving the email from the print manager 60. FIG. 7 is a flowchart illustrating the process of generating a print queue at the terminal according to the first functional configuration illustrated in FIG. 3.

The mail client 13 of the terminal 10 receives the email sent from the print manager 60, and displays the received email (S501).

The user operates the displayed operation page to generate the print queue 14 at the terminal (S503). The mechanism that creates at the terminal 10 a print queue corresponding to a print queue at the server such as the print manager 60 may be implemented by use of Web Point&Print of Windows (registered trademark), for example. Since the Web browser 11 and the operation-page generating unit 65 exchange data through HTTP communication, proper operations can be performed even under the presence of general security mechanisms such as the firewall 30.

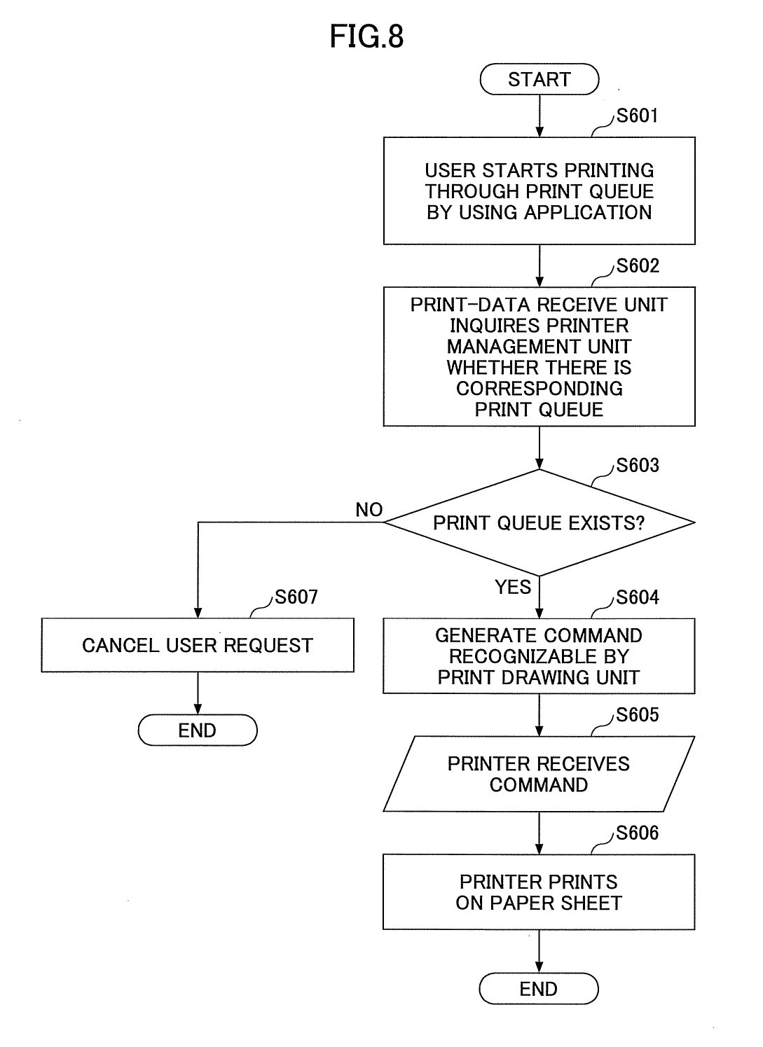

In the following, a description will be given of a print process to print at the printer 20 from the application 12 of the terminal 10. FIG. 8 is a flowchart illustrating a print process according to the first functional configuration illustrated in FIG. 3. In FIG. 8, a user starts a print process through the print queue 14 by use of the application 12 (S601)

The Print-Data Receive Unit 67 of the Print manager 60 receives the print request inclusive of print data. The print-data receive unit 67 then queries the printer management unit 62 whether there is a print queue specified by the print request (S602, S603). Here, a print queue is a time-limited print queue. Print queues are automatically deleted upon passage of a certain time period because the indefinite disclosure of queues would create network vulnerability.

If there is no queue, the print manager 60 denies and cancels the user request, and brings the print process to an end (S607). If there is a print queue, the print drawing unit 68 generates commands processable by the printer 20 (S604). The print drawing unit 68 may change setting information contained in the print request in accordance with the access control information attached to the print queue, and may then generate image data by use of the print data contained in the print request. The print drawing unit 68 then controls the print unit 21 of the printer 20 to print the image data according to the setting information conforming to the permitted print functions.

The printer 20 receives commands from the print manager 60 (S605), and starts printing on a paper sheet (S606). The printer 20 may use the recorded user information to authenticate the user ID of the user who has come to take a printout, thereby producing the printout only upon successful authentication.

The first functional configuration illustrated in FIG. 3 creates print queues to which access control information linked to the printer driver 62p is attached, and controls a print process based on the access control information corresponding to the created print queues. In the following, a description will be given of another configuration by which a print process requested from outside the local area network 200 is controlled without using print queues.

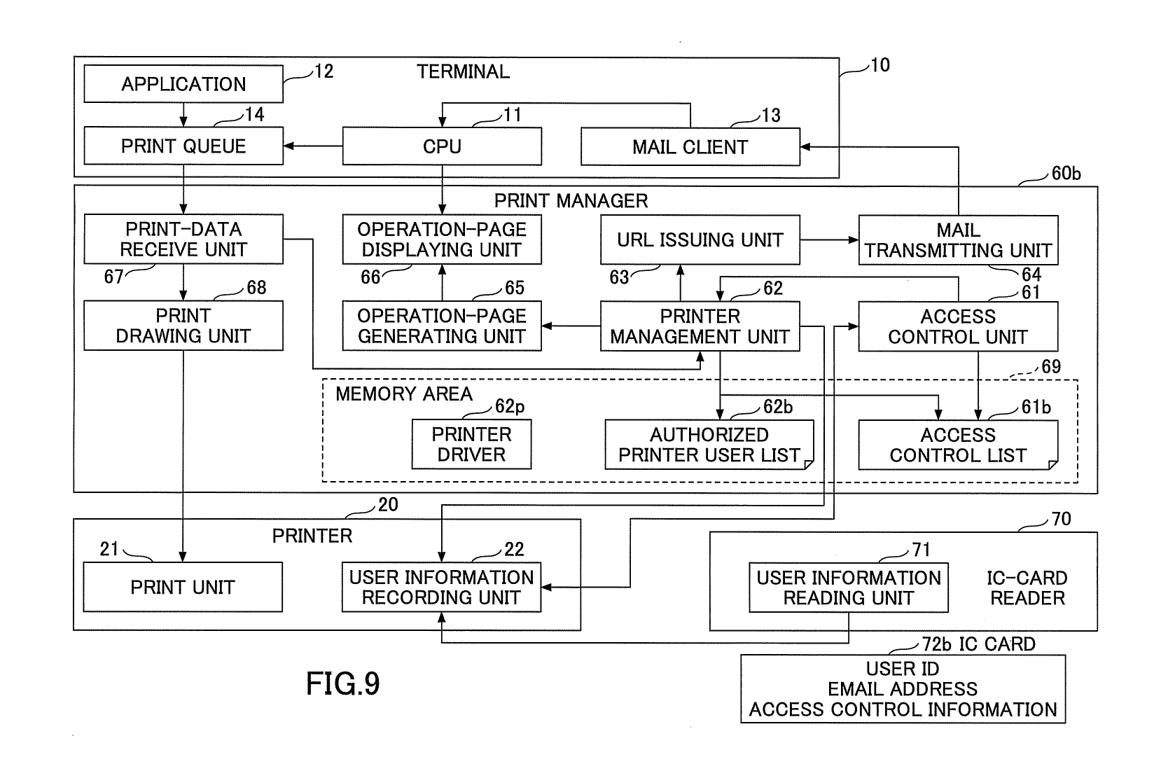

FIG. 9 is a block diagram illustrating a second functional configuration of the print system according to the embodiment. In FIG. 9, the same or similar functions as those of the first functional configuration illustrated in FIG. 3 are referred to by the same numerals, and a description thereof will be omitted. The second functional configuration illustrated in FIG. 9 differs from the first functional configuration illustrated in FIG. 3 in that an access control list 61b created by the administrator in advance is stored in the memory area 69 in addition to a authorized printer user list 62b. Further, a printer driver 62p usable in common for various types of models is stored in the memory area 69. In the second functional configuration, the user information read from an IC card 72b carried by a user includes a user ID and an email address. User's access control information is obtained from the access control list 61b.

In a print manager 60b, as in the first functional configuration illustrated in FIG. 3, the URL issuing unit 63 and the mail transmitting unit 64 correspond to the mail server function, and the operation-page generating unit 65 and the operation-page displaying unit 66 correspond to the Web server function.

The access control unit 61 refers to the access control list 61b to perform authentication by using user information read by the IC-card reader 70 to determine whether the user is authorized to use the printer 20. The user information includes a user ID identifying a user and a user email address. When the user is determined to be an authorized user to use the printer, the access control unit 61 registers the user's user ID and email address in the authorized printer user list 62b together with the data indicative of the present time.

The access control list 61b is a list that associates printer information indicative of usable printers with print functions permitted to be used with the usable printers on a user-ID-specific basis. The access control list 61b is prepared in advance by the administrator, and is stored in the memory area 69 of the print manager 60b.

The authorized printer user list 62b lists valid periods on a user-ID-specific basis with respect to users determined to be authorized printer users where the valid periods indicate periods during which printing is permitted. The authorized printer user list 62b is stored in the memory area 69.

The printer management unit 62 manages one printer driver 62p that is installed in advance in the print manager 60b and stored in the memory area 69. In response to a request from the access control unit 61, the printer management unit 62 uses the user ID contained in the user information to refer to the access control list 61b, thereby checking the print functions permitted to the user. The operation page discloses an interface to the printer driver 62p and the permitted print functions.

The URL issuing unit 63 issues a URL that specifies the address of the operation page in response to a request from the printer management unit 62. The URL issuing unit 63 provides the email address included in the user information and the issued URL to the mail transmitting unit 64. The valid period of the issued URL may be managed by use of the authorized printer user list 62b.

The mail transmitting unit 64 attaches the URL issued by the URL issuing unit 63 to an email, and specifies the user email address, thereby transmitting the email to a mail server to which the terminal 10 is connected.

In response to a request from the printer management unit 62, the operation-page generating unit 65 creates an interface to the print queue of the printer driver 62p.

The operation-page displaying unit 66 displays the operation page upon request from the terminal 10. The operation page may be a Web page. The operation page provides the functions used to create a print queue at the terminal 10. The period for displaying the page corresponding to the URL requested by the terminal 10 may be limited to the valid period. In such a case, the operation-page displaying unit 66 refers to the authorized printer user list 62b to acquire the valid period of the requested URL, and then compares the valid period with the present time to control display on the terminal 10.

The print-data receive unit 67 receives a print request from the print queue 14 of the terminal 10. The print request from the terminal 10 may be made by using the IPP (Internet Printing Protocol), for example. Encryption (e.g., HTTPS) using SSL may be utilized. The print request includes a user ID for identifying a user, print data, and setting information specified by the user regarding the print operation. The print-data receive unit 67 notifies the printer management unit 62 of the print request. The printer management unit 62 uses the user ID to refer to the authorized printer user list 62b, thereby checking whether the user is a user authorized to use the printer. When the check results indicate that the user is an authorized printer user, the print-data receive unit 67 causes the print drawing unit 68 to print the print data in accordance with the permitted print functions.

The print drawing unit 68 has the drawing function for existing printer drivers. The print drawing unit 68 refers to the access control list 61b by using the user ID specified in the request supplied from the print-data receive unit 67, thereby checking whether the setting information is consistent with the print functions permitted to the user. Based on the check results, the print drawing unit 68 uses the print data to generate image data according to the permitted print functions. The print drawing unit 68 further controls the print unit of the printer 20 through the permitted print functions to print the image data.

A user permitted to use only duplex printing may request one-side printing. Even in such a case, duplex printing is performed without regard to the user intention through the controls as described above.

The print manager 60b has the hardware configuration illustrated in FIG. 4. The functional blocks 61 through 68 of the print manager 60b illustrated in FIG. 9 are implemented by the CPU 31 executing respective programs. The memory area 69 of the print manager 60b may be provided in the memory unit 32 and/or the storage device 37.

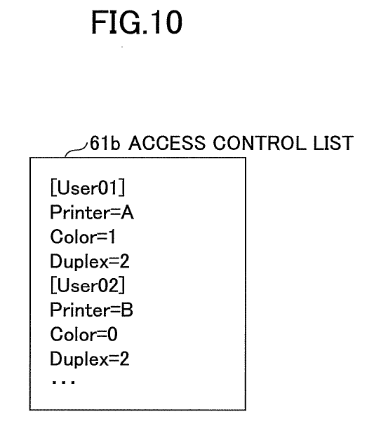

FIG. 10 is a drawing illustrating the data structure of an access control list according to the second functional configuration illustrated in FIG. 9. The access control list 61b illustrated in FIG. 10 includes printer information indicative of usable printers and access control information on a user-ID-specific basis. In the illustrated example, a user having the user ID “User01” is authorized to use the printer “A”. Upon using this printer “A”, color printing is permitted (Color=1), but only duplex printing (Duplex=2) is allowed.

The permission to use color printing (Color=1) indicates that the user can select either color printing or black-&—white printing. An indication of no color printing (Color=0) indicates that black-&-white printing is performed since color printing is not permitted.

The indication of duplex printing (Duplex=2) means that the user is not allowed to use one-side printing. Even if the user makes a setting to use one-side printing, duplex printing is forcibly used.

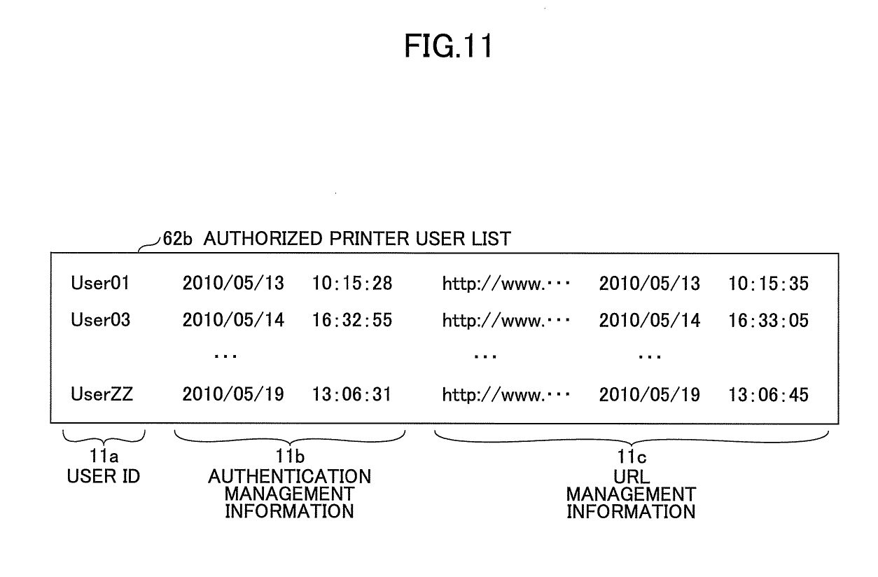

FIG. 11 is a drawing illustrating the data structure of an authorized printer user list according to the second functional configuration illustrated in FIG. 9. As illustrated in FIG. 11, the authorized printer user list 62b includes a user ID 11a, authentication management information 11b, and URL management information 11c separately for each user who is authorized to be a printer authorized user. In the second functional configuration, each user's access control information is managed by use of the access control list 61b, and is not listed in the authorized printer user list 62b.

The user ID 11a and the authentication management information 11b are registered when the access control unit 61 performs user authentication. The user ID 11a uniquely identifies each user. The authentication management information 11b indicates the date and time of registration. Alternatively, the authentication management information 11b indicates the date and time of expiration of authentication.

The URL management information 11c indicates a URL issued by the URL issuing unit 63 and the date and time of issuance. Alternatively, the date and time may indicate the valid period of the URL. When the valid period of a URL is not an item to be controlled, the date and time of issuance may be omitted.

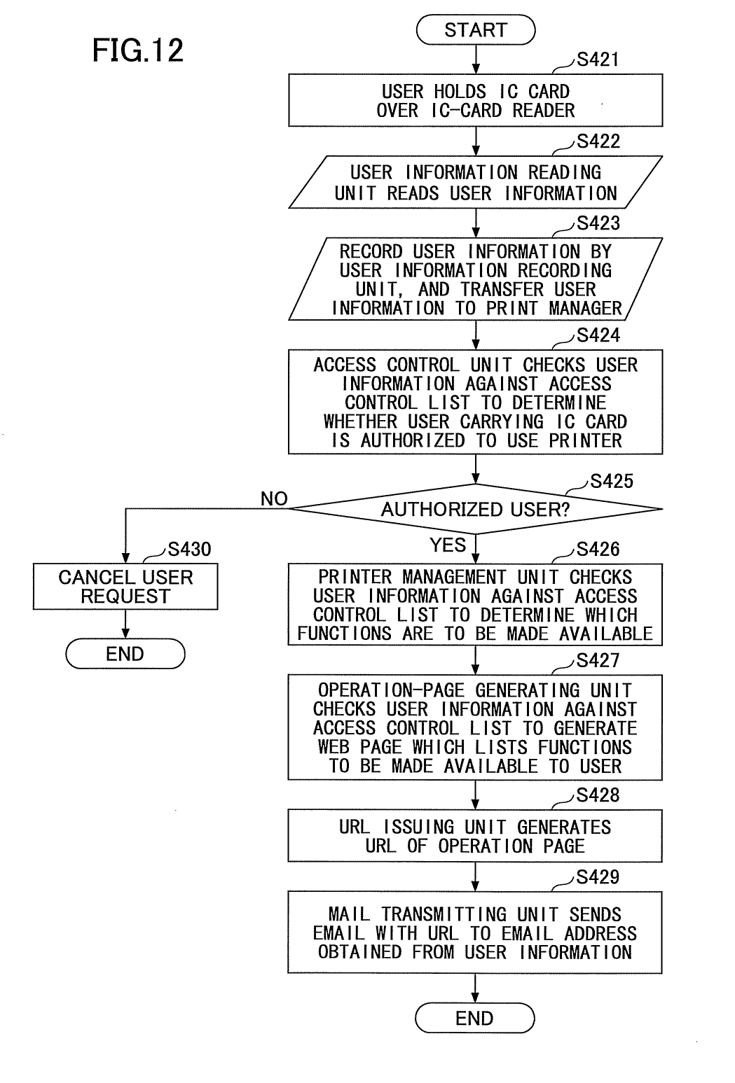

FIG. 12 is a flowchart illustrating the process of providing a notice of an operation page according to the second functional configuration illustrated in FIG. 9. In FIG. 9, a user who would like to use the printer 20 holds a carried item such as an IC card over the IC card reader to which the printer 20 is connected (S421).

The user information reading unit 71 of the IC-card reader 70 reads user information from the IC card (S422). The user information includes a user ID and a user email address.

The printer 20 transfers the acquired user information to the print manager 60 (S423). The printer 20 may record the user information. When print data is supplied from the user, the printer 20 may request the user to enter his/her user ID, and may perform printing upon authenticating the user as a printer authorized user by use of the recorded user information. Such authentication at the time of printing makes it possible to prevent the printout from being taken by an unauthorized user. Time may also be recorded in order to provide a mechanism by which to prohibit printing after the passage of a predetermined time period.

When the print manager 60 receives the user information from the printer 20, the access control unit 61 uses the user information to refer to the access control list 61b, thereby checking whether the user carrying the IC card is a user authorized to use the printer 20 (S424, S425). If the user is not a legitimate user, or is not a user authorized to print by use of the printer, the request is denied, and the procedure comes to an end (S430). The operation panel of the printer 20 may display an indication that the information provided by the IC card is not valid.

In the second functional configuration, one printer driver 62p usable in common for various models of printers 20 managed by the print manager 60 is installed in the print manager 60 and managed by the printer management unit 62. Disclosure of printer functions may be controlled by use of each user's access control information on a printer specific basis. In such a case, plural print queues may be installed with respect to a single printer driver. The printer management unit 62 refers to the user information to check the user's access control information (S426). For example, such a control procedure may be used that the administrator can use all the functions of the printer 20 while general users cannot use color printing.

The operation-page generating unit 65 generates an operation page for making the generated print queues available to the public (S427). The operation-page displaying unit 66 prepares to display the operation page that is to be made public.

The URL issuing unit 63 generates a URL of the operation page to be displayed in response to a request from the printer management unit 62 (S428). Any URL may suffice as long as it is unique. For example, a random number may be used to generate “http://www.xxx.yyy.zzz/printers/604927”. The random number portion may be encrypted by use of a predetermined algorithm using a hash function or the like as in the following example: “http://www.xxx.yyy.zzz/printers/hgdfxf2df4d”.

The mail transmitting unit 64 attaches the generated URL to email, and sends the email to an email address obtained from the user information (S429).

The print queue generating process at the terminal according to the second functional configuration of FIG. 9 is the same as the print queue generating process at the terminal according to the first functional configuration of FIG. 7 previously described, and a description thereof will be omitted.

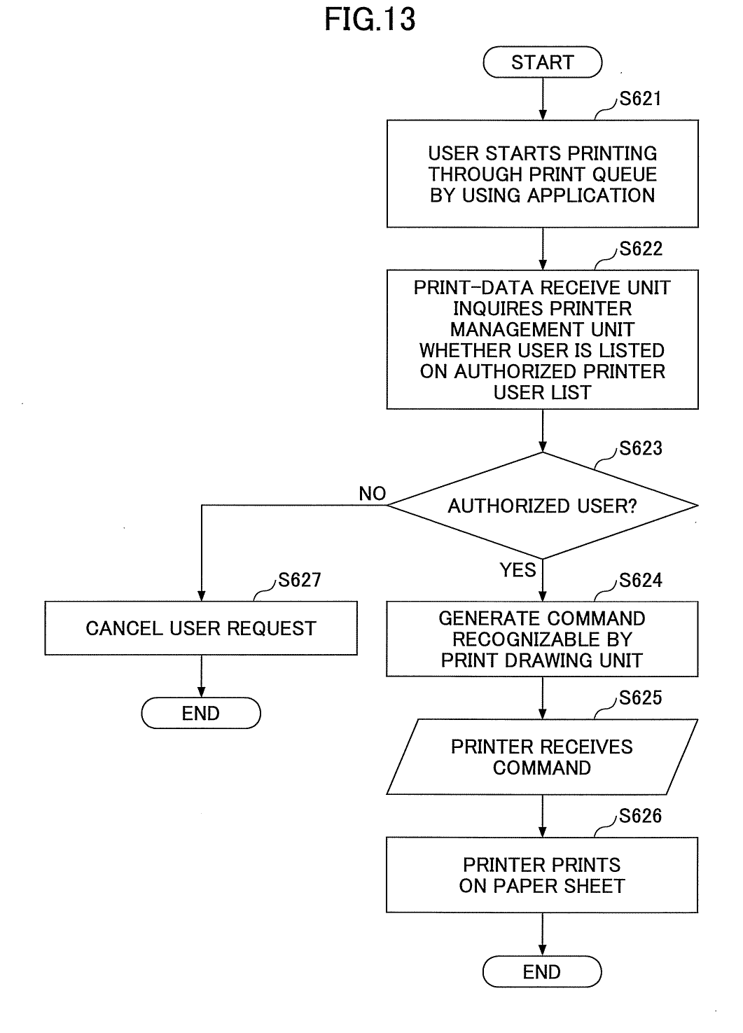

FIG. 13 is a flowchart illustrating a print process according to the second functional configuration illustrated in FIG. 9. In FIG. 13, a user starts a print process through the print queue 14 by use of the application 12 (S621)

The print-data receive unit 67 of the print manager 60 receives the print request inclusive of print data. The print-data receive unit 67 then queries the printer management unit 62 whether the user ID specified by the print request is registered as that of an authorized printer user (S622, S623). The printer management unit 62 refers to the authorized printer user list 62b to check whether the user ID is registered. If the user ID is a registered ID, the printer management unit 62 refers to the access control list 61b to acquire access control information associated with the user ID. The printer management unit 62 notifies the print-data receive unit 67 of the presence/absence of user-ID registration, and also notifies of the access control information if the user ID is already registered.

If the user ID is not registered as that of an authorized printer user, the print manager 60 denies and cancels the user request, and brings the print process to an end (S627). If the user ID is already registered as that of an authorized printer user, the print drawing unit 68 generates commands processable by the printer 20 (S624). The print drawing unit 68 may change setting information contained in the print request in accordance with the access control information corresponding to the user ID received from the printer management unit 62, and may then generate image data by use of the print data contained in the print request. The print drawing unit 68 then controls the print unit 21 of the printer 20 to print the image data according to the setting information conforming to the permitted print functions.

The printer 20 receives commands from the print manager 60 (S625), and starts printing on a paper sheet (S626). The printer 20 may use the recorded user information to authenticate the user ID of the user who has come to take a printout, thereby producing the printout only upon successful authentication.

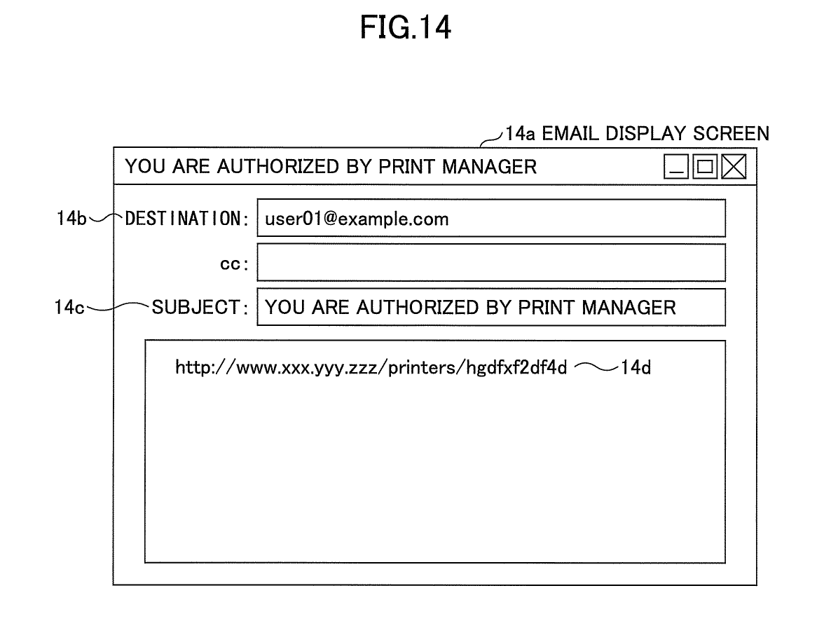

In the following, a description will be given of an example of a screen displayed at the terminal 10. FIG. 14 is a drawing illustrating an example of a displayed email transmitted from a print manager. In FIG. 14, an email display screen 14a displayed at the terminal 10 shows the contents of an email, which is transmitted from the mail transmitting unit 64 to the user email address after the user is authenticated based on user information read by the IC-card reader 70.

The email display screen 14a shows the user email address in a destination field 14b, and indicates successful authentication by the print manager 60 in a subject field 14c. The contents of this email include an address 14d indicative of the URL of an operation page that is used for installing a printer driver. The address 14d is the URL generated by the URL issuing unit 63.

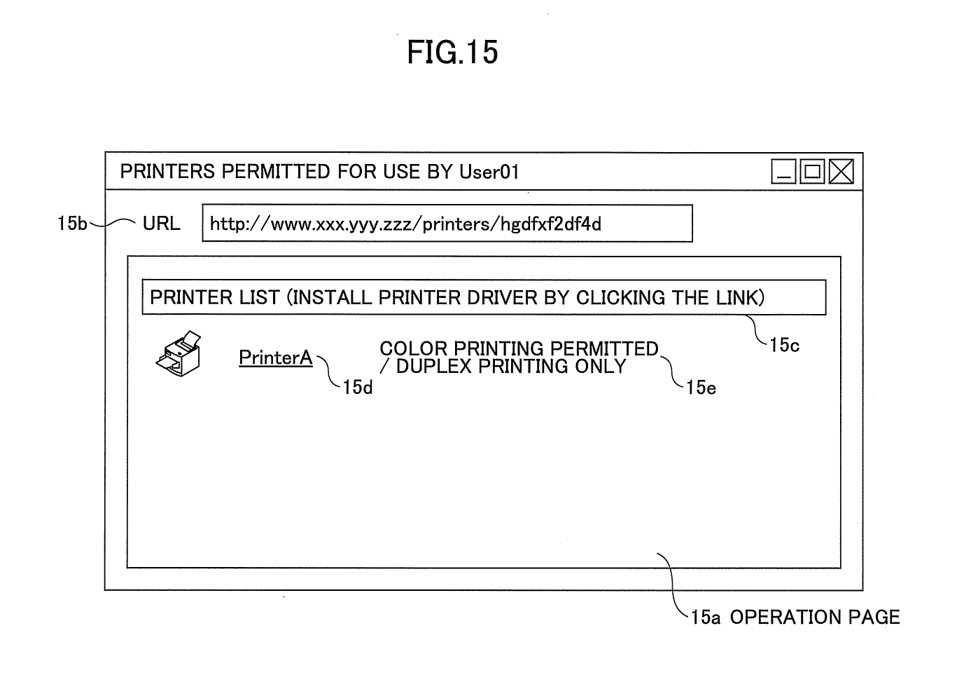

When the user accesses the address 14d, an operation page 15a as illustrated in FIG. 15 is displayed by the Web browser 11. FIG. 15 is a drawing illustrating an example of an operation page that is used for installing a printer driver. In FIG. 15, the Web browser 11 shows in a URL field 15b the address 14d that the user has accessed from the email display screen 14a. The operation page 15a shows a list of printers for which printer drivers can be installed.

The operation page 15a displays a message 15c prompting the user to install a printer driver, an operation button 15d for initiating installation upon clicking, and access control information 15e assigned to the user.

In the embodiments described heretofore, security measures can be applied to a print request arriving from outside the local area network 200 similarly to the manner in which security measures are applied to a print request generated within the local area network 200. Namely, only a user who is authorized to use a printer in the local area network 200 can send an acceptable print request from outside the local area network 200. Further, printing is performed in accordance with the access control information assigned to the user.

The local area network 200 may be formed within a corporation. Employees may be registered as authorized printer users in the local area network 200 of the corporation. In such a case, an employee on a business trip can use the terminal 10 to access the local area network 200 through the Internet 100, and can print to the printer 20 installed in the local area network 200.

Inside the local area network 200, the authorized printer user list 62b may be referred to in order to check whether the user is registered as an authorized printer user. This arrangement properly prevents the printer 20 from being exposed to an unauthorized access coming from outside.

Moreover, even when a user registered on the authorized printer user list 62b issues a print request, printing is performed in accordance with the access control information assigned to the user. Accordingly, security measures imposed on print requests originating inside the local area network 200 are invariably applied to all print requests.

Further, the present invention is not limited to these embodiments, but various variations and modifications may be made without departing from the scope of the present invention.

The present application is based on Japanese priority applications No. 2009-207260 filed on Sep. 8, 2009 and No. 2010-127294 filed on Jun. 2, 2010, with the Japanese Patent Office, the entire contents of which are hereby incorporated by reference.

What is claimed is:

1. A print system in which a terminal uses a print device through the Internet to cause the print device installed in a local network to print, comprising:
a user checking unit configured to check whether a user is a user authorized to use the print device in the local network;
an operation page providing unit configured to provide an accessible operation page to the user upon determining that the user is a user authorized to use the print device; and
a print controlling unit configured to cause the print device to print according to access control information associated with the user in response to a print request received through the Internet, the print request being made by the terminal by using a printer driver of the print device, the terminal being situated outside the local network, and the printer driver being installed by use of the operation page.

2. The print system as claimed in claim 1, wherein the user checking unit includes:
an access control unit configured to check, based on user information obtained from the user, whether the user is a user authorized to use the print device; and
a printer management unit configured to manage the printer driver of the print device and to determine print functions to be made available to the user based on the access control information associated with the user,
and the operation page providing unit includes:
a mail server unit configured to issue an address of the operation page for allowing the printer driver to be installed and to notify the user of the address through a firewall of the local network; and
a Web server unit configured to generate the operation page indicating the print functions and to transmit the operation page through the firewall in response to an access from the terminal, the access being directed to the address of the operation page issued by the mail server unit,
wherein upon receiving, through the firewall, the print request from the terminal that has installed the printer driver by use of the operation page, the print control unit generates image data by using print data contained in the print request, and causes the print device to print the image data, the image data being generated in accordance with the access control information.

3. The print system as claimed in claim 2, wherein the print control unit includes:
a print-data receive unit configured to check, upon receiving the print request from the terminal through the firewall, whether the user having made the print request is a user authorized to use the print device; and
a print drawing unit configured to change setting information contained in the print request in accordance with the access control information associated with the user, the print drawing unit changing the setting information upon determining that the user is a user authorized to use the print device, the print drawing unit using the print data to generate the image data to cause the print device to print the image data according to the changed setting information.

4. The print system as claimed in claim 2, wherein the access control unit refers to an access control list to determine whether the user identified from the user information is a user authorized to use the print device, the access control list storing, on a user-specific basis, indications of print devices usable by users and the access control information indicative of print functions permitted to the users, wherein the access control unit registers the user in an authorized printer user list upon determining that the user is a user authorized to use the print device.

5. The print system as claimed in claim 4, wherein the printer management unit refers to the access control list to acquire the access control information associated with the user specified by the user information, and determines the print functions to be made available to the user based on the acquired access control information.

6. The print system as claimed in claim 2, wherein communication relating to the operation page transmitted to the terminal is encrypted.

7. The print system as claimed in claim 2, wherein the user information is read from an object carried by the user and acquired through the print device, and the access control unit notifies the print device that the user information is invalid upon determining that the user is not a user authorized to use the print device.

8. The print system as claimed in claim 2, wherein the mail server unit notifies the user of the address of the operation page through email.

9. A print control apparatus of a print system in which a terminal uses a print device through the Internet to cause the print device installed in a local network to print, comprising:
a user checking unit configured to check whether a user is a user authorized to use the print device in the local network;
an operation page providing unit configured to provide an accessible operation page to the user upon determining that the user is a user authorized to use the print device; and
a print controlling unit configured to cause the print device to print according to access control information associated with the user in response to a print request received through the Internet, the print request being made by the terminal by using a printer driver of the print device, the terminal being situated outside the local network, and the printer driver being installed by use of the operation page.

10. The print control apparatus as claimed in claim 9, wherein the user checking unit includes:
an access control unit configured to check, based on user information obtained from the user, whether the user is a user authorized to use the print device; and
a printer management unit configured to manage the printer driver of the print device and to determine print functions to be made available to the user based on the access control information associated with the user,
and the operation page providing unit includes:
a mail server unit configured to issue an address of the operation page for allowing the printer driver to be installed and to notify the user of the address through a firewall of the local network; and
a Web server unit configured to generate the operation page indicating the print functions and to transmit the operation page through the firewall in response to an access from the terminal, the access being directed to the address of the operation page issued by the mail server unit,
wherein upon receiving, through the firewall, the print request from the terminal that has installed the printer driver by use of the operation page, the print control unit generates image data by using print data contained in the print request, and causes the print device to print the image data, the image data being generated in accordance with the access control information.

11. The print control apparatus as claimed in claim 10, wherein the print control unit includes:
a print-data receive unit configured to check, in response to the print request received from the terminal through the firewall, whether the user having made the print request is a user authorized to use the print device; and
a print drawing unit configured to change setting information contained in the print request in accordance with the access control information associated with the user, the print drawing unit changing the setting information upon determining that the user is a user authorized to use the print device, the print drawing unit using the print data to generate the image data to cause the print device to print the image data according to the changed setting information.

12. The print control apparatus as claimed in claim 10, wherein the access control unit refers to an access control list to determine whether the user identified from the user information is a user authorized to use the print device, the access control list storing, on a user-specific basis, indications of print devices usable by users and the access control information indicative of print functions permitted to the users, wherein the access control unit registers the user in an authorized printer user list upon determining that the user is a user authorized to use the print device.

13. The print control apparatus as claimed in claim 12, wherein the printer management unit refers to the access control list to acquire the access control information associated with the user specified by the user information, and determines the print functions to be made available to the user based on the acquired access control information.

14. The print control apparatus as claimed in claim 10, wherein communication relating to the operation page transmitted to the terminal is encrypted.

15. The print control apparatus as claimed in claim 10, wherein the user information is read from an object carried by the user and acquired through the print device, and the access control unit notifies the print device that the user information is invalid upon determining that the user is not a user authorized to use the print device.

16. The print control apparatus as claimed in claim 10, wherein the mail server unit notifies the user of the address of the operation page through email.

17. A method of controlling printing performed by a print control apparatus of a print system in which a terminal uses a print device through the Internet to cause the print device installed in a local network to print, comprising:
a user checking step of checking whether a user is a user authorized to use the print device in the local network;
an operation page providing step of providing an accessible operation page to the user upon determining that the user is a user authorized to use the print device; and
a print controlling step of causing the print device to print according to access control information associated with the user in response to a print request received through the Internet, the print request being made by the terminal by using a printer driver of the print device, the terminal being situated outside the local network, and the printer driver being installed by use of the operation page.

18. The method as claimed in claim 17, wherein the user checking step includes:
an access control step of checking, based on user information obtained from the user, whether the user is a user authorized to use the print device; and
a printer management step of managing the printer driver of the print device, and determining print functions to be made available to the user based on the access control information associated with the user,
wherein the operation page providing step includes:
an operation page generating step of generating the operation page indicative of the print functions, the operation page enabling the printer driver to be installed.
an address issuing step of issuing an address of the operation page;
an address notifying step of notifying the user of the address of the operation page via a firewall of the local network; and
an operation page transmitting step of transmitting the operation page through the firewall in response to an access from the terminal, the access being directed to the address of the operation page,
and wherein the print control step includes:
a print data receive step of receiving print data and setting information contained in the print request, the print request being sent from the terminal that has installed the printer driver by use of the operation page, the operation page being transmitted through the firewall; and
a print drawing step of changing the setting information in accordance with the access control information, and generating image data by use of the print data to cause the print device to print the image data according to the changed setting information.

19. The method as claimed in claim 18, wherein the print data receive step checks whether the user having made the print request is a user authorized to use the print device, and the print drawing step changes the setting information contained in the print request in accordance with the access control information associated with the user upon determining that the user is a user authorized to use the print device, and uses the print data to generate the image data to cause the print device to print the image data according to the changed setting information.
